(19) United States
(12) Patent Application Publication
(10) Pub. No.: US 2008/0007206 A1
(43) Pub. Date: Jan. 10, 2008

(54) Universal battery adapter system

(76) Inventors: George Velissaris, Northbrook, IL (US); Willard Strom, Mundelein, IL (US)

Correspondence Address: Clifford Kraft, 320 Robin Hill Drive, Naperville, IL, 60540, US

(21) Appl. No.: 11/478,899

(22) Filed: Jun. 30, 2006

(51) Int. Cl. H02J 7/00

(52) U.S. Cl. 320/106

(57) ABSTRACT

A battery interchangeability system having an application device requiring a battery of a particular size, an insert device that can be inserted into the application device in place of the required battery, and a battery of a second size that is smaller than original size so that at least one smaller battery can be inserted into the insert device. It is also possible for multiple batteries of a smaller size can be inserted into a single insert and used in parallel or series. In particular, the larger cell size can be D, C or AA size, while the smaller cell size can be C, AA or AAA size. A second, smaller insert device can be used which is inserted into a first, larger insert device with the battery or batteries inserted into the smaller insert device. Optionally, several smaller batteries can be placed around the axis of an insert device in a turret arrangement. Batteries in this arrangement can be placed into the device from either the top or side. An optional cap can be used when the batteries are inserted from the top.

### BACKGROUND

1. Field of the Invention

The present invention relates generally to batteries and more particularly to a universal battery adapter system that allows smaller batteries to be used in applications designed for larger batteries.

2. Description of the Prior Art

It is known in the art to use numerous different battery cells in various applications. Many of these cells produce an output voltage of approximately 1.5 volts. Of this type, there are D cells, A cells, AA cells and AAA cells in common use. It is annoying for a typical consumer to have numerous pieces of equipment like flashlights, TV controls, game controls, cameras, GPS units, radios, etc. that all use different sized batteries with the same output voltage.

If an AA cell could be substituted for a C cell, it has been computed that it lasts about half as long under the same load. However, an AA cell costs only one third what a C cell costs. The same time/cost ratio holds approximately between other cell sizes.

It would be advantageous to have a universal battery adapter system that would allow different sized 1.5 volt batteries to be substituted for one-another in a particular application.

### SUMMARY OF THE INVENTION

The present invention relates to a battery interchangeability system where an application device requiring a battery of a particular cell size (such as a flashlight, music device, radio, etc.) can receive an insert device or other device in place of the required battery. One or more batteries of a second cell size smaller than original cell size can be put into the insert device, and power, or partially power the application device. In some embodiments of the invention, multiple batteries of a smaller size can be put into a single insert and used in parallel or series. In particular, the larger cell size can be D, C or AA, while the smaller cell size can be C, AA or AAA. In some embodiments of the invention, a second, smaller insert device can be used which is inserted into a first, larger insert device with the battery or batteries inserted into the smaller insert device.

In other embodiments of the present invention several smaller batteries can be placed around the axis of an insert device in a turret arrangement. Batteries in this arrangement can be placed into the device from the top or side (top-loaded or side-loaded). An optional cap can be used when the batteries are inserted from the top. Multiple inserts of varying size can also be used.

A particular embodiment of the invention uses a generally cylindrical battery insert with a central longitudinal axis, a top end and a bottom end, where the bottom end has a bottom outer surface. The insert can have an outside diameter and length approximately equal to that of a first standard cylindrical battery cell type (such as a D cell). The insert can contain an approximately cylindrical cavity concentric with the central longitudinal axis where the cavity has an inside diameter approximately equal to the outside diameter of a second standard cylindrical battery cell type (such as an AA cell). The cavity can have an open top end coincident with the top end of the insert and a closed or partially closed bottom end in proximity to the bottom end of the insert. The bottom end of the cavity can contain an electrode electrically linking the outer bottom surface of the insert with the inner surface of the bottom of the cavity. Generally, the cavity can have a length measured from the open top end to the inner bottom surface that is approximately equal to that of the second standard battery type; however, it can be shorter. In this manner, a battery of the second standard cylindrical battery type can be inserted into the cavity, and the insert can be placed into a device requiring a battery of said first standard cylindrical battery type. In this way, the battery of the second standard battery type can power the device.

Other embodiments of the present invention can contain washers or endcaps or be cylinders fitted with internal or external fins.

### DESCRIPTION OF THE DRAWINGS

FIG. 1A shows a perspective view of an embodiment of the present invention with one cell inserting into a larger size.

FIG. 1B shows a perspective view of an insert showing internal detail.

FIG. 2 shows the use of two inserts.

FIG. 3 shows a small cell such as an AAA cell inserted into a much larger cell such as a D cell.

FIG. 4 shows size differences between D cells, C cells, AA cells and AAA cells.

FIGS. 5A-5B show a cross-section of an embodiment of the invention.

FIG. 6 shows the use of two D cell or C cell inserts in a flashlight allowing AA or AAA cells to be used.

FIGS. 7A-7C show a turret arrangement where several AA or AAA cells can be used in parallel in a much larger insert such as a D cell size.

FIG. 8 shows an insert that is shorter than the battery it receives.

FIGS. 9A-9B show open bottom embodiments of the present invention. FIG. 9B also shows a two cell embodiment.

FIGS. 10A-10B show “washer” or “endcap” embodiments.

FIGS. 11A-11D show various frame or fin type embodiments.

Several drawings and illustrations have been presented to better aid in understanding the present invention. The scope of the present invention is not limited to what is shown in the figures.

### DETAILED DESCRIPTION OF THE INVENTION

The present invention relates to the use of an insert or system of inserts that permit smaller cylindrical battery cells to work in applications that normally require larger diameter cells. An example of one use of the present invention is to use AA or AAA cells to power a flashlight or other device designed to use C or D cells. Alternatively, AAA cells can be used to power devices designed for AA or larger cells, etc. The use of smaller cells has several advantages. The next-sized smaller cell normally lasts about ½ the time of a particular cell; however, it generally only costs ⅓ the price. This leads to a cost advantage. Another advantage of the present invention is that a user can outfit a suite of electronic equipment to use only one size battery cell (such as AA or AAA) even though each piece of equipment was designed to use different size cells. This provides a major advantage since the user can purchase the single cell size in much larger quantities, leading to even more cost savings.

In an alternate embodiment to be described, the user can place several smaller cells such as AAA cells in a turret type insert where 3 or 4 cells can be used in parallel. In this arrangement, the use-life can be the same, or greater, than that of the original cell size with the cost advantages discussed above of quantity buying of a single smaller cell size.

A particular example of use of the present invention can be found in flashlight sets that are popular. These sets contain several different sized flashlights. Each size may require different cell sizes. Using the present invention, the user needs purchase one or at most two cell sizes. For example, the user could outfit the entire suite for AAA size cells, or alternatively, the user could use AAA for the smallest light and then outfit all the remaining lights for AA size cells. If the user chose to use only AAA cells, AAA cells might be used in the smallest light, a single AA to AAA insert in the next sized light, and AAA cells in a turret arrangement in the largest light.

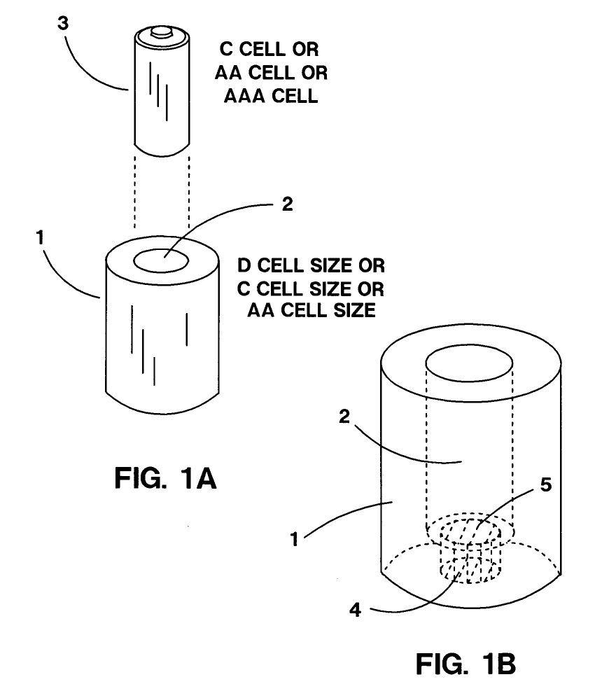

A particular embodiment of the present invention is shown in FIG. 1A and includes a cylindrical insert that converts one particular cell size to another. This insert resembles a coffee-cup structure. The structure of this embodiment can resemble a coffee cup with no handle. A first cell type such as a C size cell 3 can be converted to a D size cell using an insert 1. The insert 1 can contain a cavity 2 that is adapted to receive the smaller battery 3. The insert 1 can itself then be directly put into the application device exactly as if it were itself a cell of the correct size.

FIG. 1B shows a perspective view of the insert 1 from FIG. 1A where internal details can be seen. The cavity 2 is normally open on the top and has a floor or bottom that matches the length of the smaller cell. A conductor 5 can pass through the base of the insert to present an open surface 4 on the outside bottom of the insert. This surface 4 can make electrical contact with the spring or any other negative electrical contact of the receiving apparatus, and provide electrical conductivity through to the bottom to the negative contact of the battery at the surface 5. The conductor can be any type of metal such as copper, brass, aluminum, steel or any other metal or alloy. The contact does not need to fill the entire bottom of the cavity, but can be a smaller button, spring or any other type of conductive contact. The preferred method is to make the surface 4 protrude a small amount outward to make positive contact. This is optional however, and a flush surface will work.

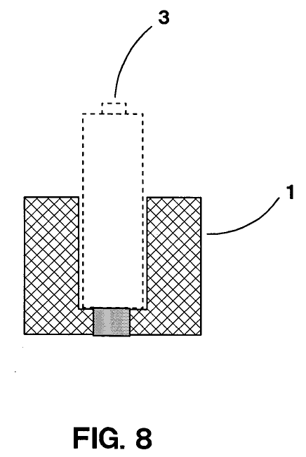

The length of the insert 1 can be such that the top of the inserted battery 3 shows its positive button protruding above the open top of the cavity 2 so that it can make contact with the positive electrode of the apparatus or another battery or insert; however, it is possible to use a half-length or any other length insert as long as it holds the battery 3 in position (See FIG. 8). In this manner, the battery 3 can power, or partially power, the apparatus. The insert 1 can be made of any rigid or semi-rigid material with insulating materials like polymers such as various plastics or Teflon being preferred. A particularly good plastic is polypropylene. Wood or even scrap metal can be used if care is used to insulate the electrical part of the device from the rest. Any rigid or semi-rigid material is within the scope of the present invention. It is also possible to use closed cell film or other foam or spongy material. An advantage of a foam or film material is that it can give buoyancy to product in water. A particular example might be a flashlight that would otherwise sink in water becoming buoyant by using a insert of the present invention made from closed cell film or from foam.

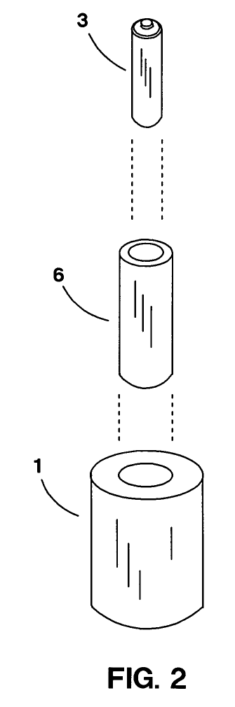

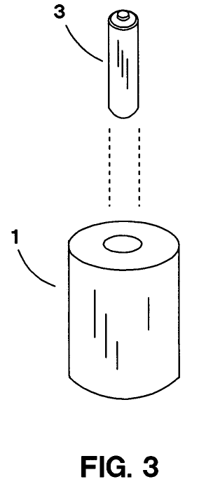

FIG. 2 shows an alternate embodiment of the present invention. Here two (or more) successively smaller insert devices can be used concentrically. For example, an insert 1 that converts a D cell size to a C cell size can receive an insert 6 that converts the C cell size to a AA cell size. A battery 3 can be put into the second insert 6. Any number of inserts can be used in tandem (either concentrically or in any other arrangement). As previously described, a different insert making only a single cell conversion can also be used (see FIG. 3).

FIG. 3 shows an embodiment of the present invention where a small battery cell 3 such as AA or AAA cell size is inserted into a much larger cell size such as D with a thick insert 1. This embodiment can be used in place of the multiple inserts shown in FIG. 2.

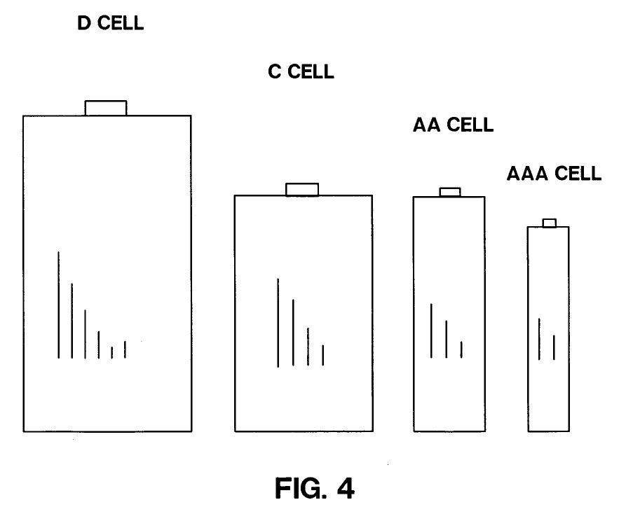

FIG. 4 shows a comparison of the heights and diameters of commonly used cells. A D cell has a height of around 2/14 inch (not counting the button) with a diameter of around 1¼ inch. A C cell has a height of around 1⅞ inch and a diameter of around 1 inch. An AA cell also has height of around 1⅞ inch with a diameter of around 9/16 inch, and an AAA cell has a height of around 1 11/16 inch with a diameter of around 7/16 inch. It can be seen from FIG. 4 that as cell sizes decrease in diameter, they also decrease in height (except for C and AA which have the same height).

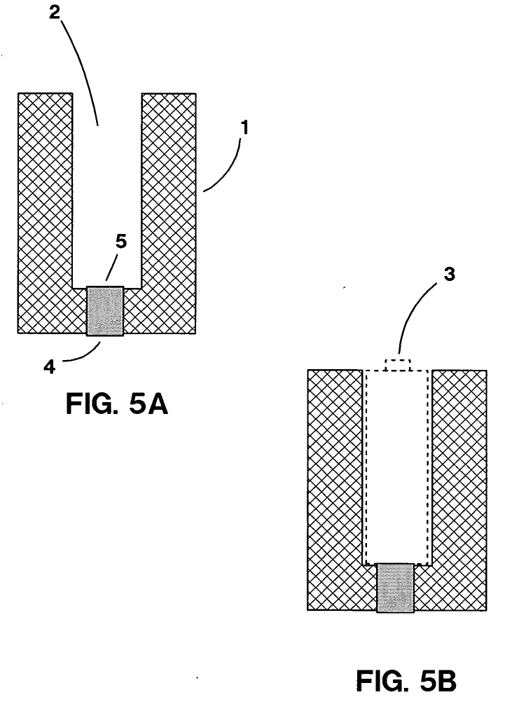

FIGS. 5A and 5B show a cross-section of a particular embodiment of the invention. The insert 1 contains a cavity 2 with a closed bottom. In the bottom of the cavity 2 contains an electrical conductor with a surface 5 facing the inside of the cavity and a surface 4 facing the bottom outside of the insert 1. The cavity 2 can be adapted to receive a battery 3 that fits into the cavity so that the bottom conductive end of the battery mates with the inner conductive surface 5, and the button on the top end of the battery 3 can protrude out of the top of the cavity 2. In this manner, when the insert is placed into an application device, the bottom outside surface 4 can contact the negative electrode from the application or the positive button of another battery or insert, and the button can contact the positive electrode of the application device or the bottom of another battery or insert. Thus, an electrical circuit is completed, and the battery in the insert 1 can power, or partially power, the application.

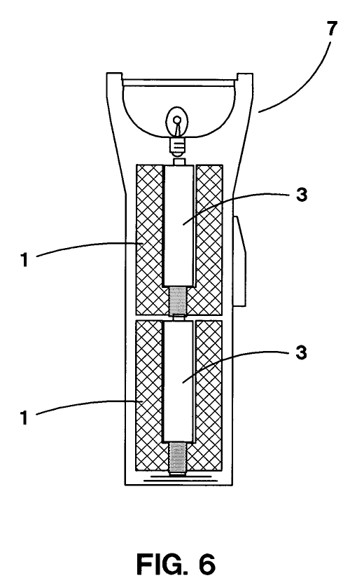

FIG. 6 shows two of the inserts from FIG. 5 used in a flashlight application 7. Each insert 1 normally contains a smaller battery 3 with the inserts placed in the flashlight in place of larger cells such as D cells or C cells. The smaller batteries 3 can be AA or AAA cells (or C cells if the flashlight normally takes D cells). The result is an efficient replacement of the costlier larger cells.

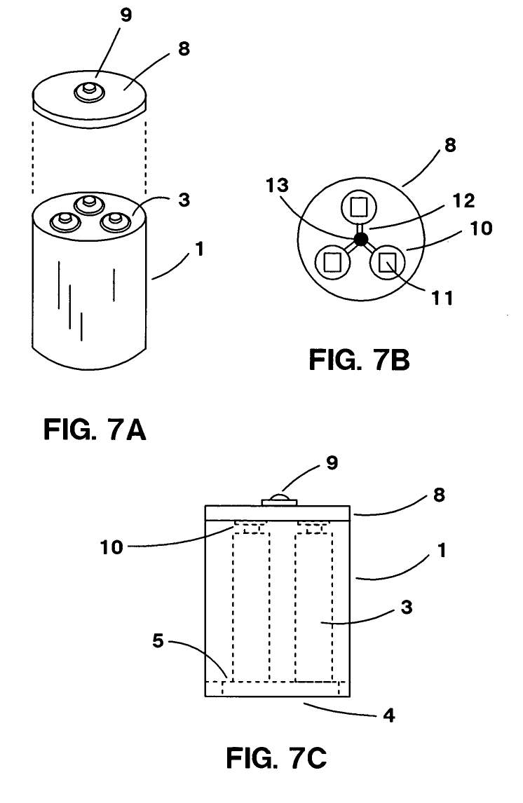

FIGS. 7A, 7B and 7C show an alternative embodiment of the present invention. In this embodiment, several smaller cells 3 are placed in an insert 1 and arranged in a turret fashion (like shells in a revolver). In this embodiment, a cap 8 can fit over the body of the insert 1 to close it. The cap can contain a top button electrode 9 that is connected on its lower side to several contacts 11. The contacts can optionally be mounted on pads or springs 10. Electrical conductors 12 can connect the contacts 11 to the bottom of the central button 13. The conductors 12 can also optionally act as springs to assure secure contact with the top buttons on the batteries 3. The bottom of the insert can contain a conductive surface 5 that allows electrical current to flow from the outside outer surface 4 of the insert 1, thus completing the circuit. While a spring force is desirable between the cap 8 and insert 1, actual springs are optional. Any method of making contact with the batteries is within the scope of the present invention.

An alternate version of the embodiment of FIGS. 7A-7C can load the batteries from the side rather than from the top. In this case, the top cap can be fixed with the batteries mounted turret style in the insert. It should be noted that turrets can be made with two, three or four batteries depending on the battery cell size and the insert size (assuming current standard battery sizes). For example, a D size turret could hold three AA cells or four AAA cells.

In still another alternate embodiment of the invention, batteries can be placed in the insert device in series (where they are electrically connected in series). In this embodiment, the insert acts to hold the batteries end-to-end so that the result is a multiple of the battery cell voltage.

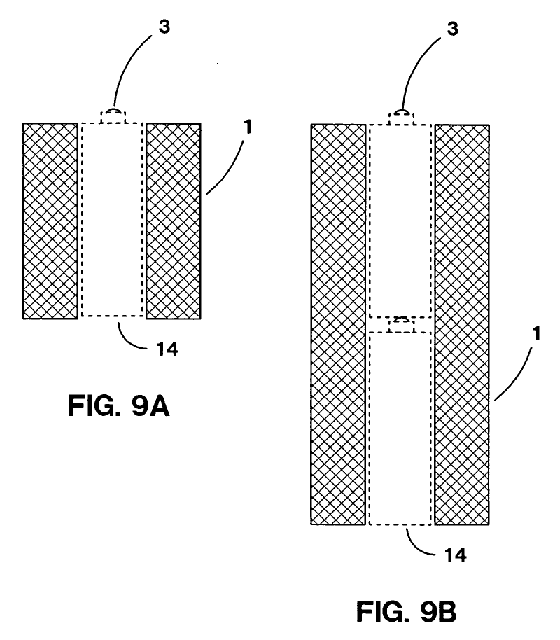

FIG. 8 shows an alternative embodiment of the invention where the insert 1 is shorter than the battery 3 it receives. The insert 1 can be any length as long as it holds the battery in position to power the application device. FIGS. 9A and 9B show open body embodiments of the invention. When an AA cell is used in place of a C cell, the entire bottom of the cavity 14 can be left open because the lengths of the AA cell and C cell are the same. This allows the base of the inserted battery to directly make electrical contact without any plug or other conductor. FIG. 9B shows a double length version of the present invention that can hold two or more smaller cells. If the conversion is from AA to C size, the bottom 14 can again left open as shown in FIG. 9B. For different conversions, the embodiment of FIG. 9B can be modified to have a solid bottom with a conductor like that of FIG. 8. The present invention can be made any length to hold any number of batteries of the same or different sizes.

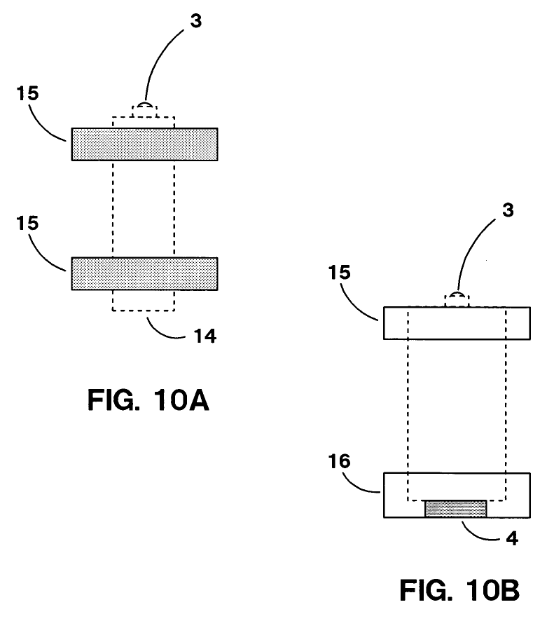

FIG. 10A shows a “washer” type embodiment of the invention. Here two disks 15 hold the battery 3 in place. The diameter of the disks 15 can match the outside diameter of the cell being replaced. The embodiment of FIG. 10A is useful for AA to C replacement where the lengths are the same. FIG. 10 B shows a similar embodiment with and “endcap” arrangement 16. This embodiment can be used with different conversions where the lengths may be different.

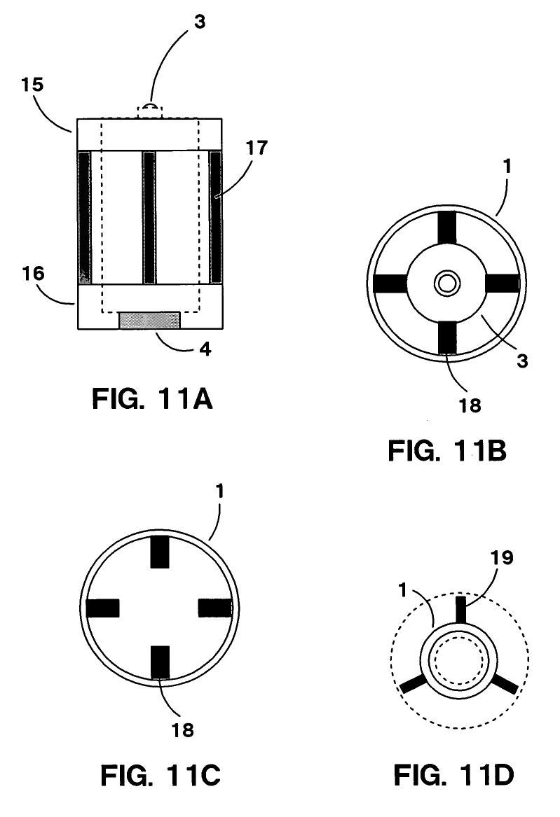

FIG. 11A shows a “frame” embodiment of the invention where the disk 15 and the endcap 16 are held spaced apart by struts or strips 17 forming side members.

FIGS. 11B-11C show an embodiment of the invention where a cylinder 1 is made with a particular wall thickness and fins 18 extend inward to match the outside diameter of the inserted battery 3. While four fins are shown in FIGS. 11B-11C, three or any other number can be used.

FIG. 11D shows a variation of the embodiment of FIGS. 11B-11C where the fins 19 face outward instead of inward. In this case the cylinder 1 matches the diameter of the inserted battery while the fins 19 match the outside diameter of the cell being replaced.

Several descriptions and illustrations have been presented to better aid in understanding the present invention. One skilled in the art will realize that many changes and variations can be made without departing from the spirit of the invention. All such changes and variations are within the scope of the present invention. In particular, any device that replaces one battery cell size with another is within the scope of the present invention.

1. A battery interchangeability system comprising, in combination:
an insert device insertable into an application that requires at least one battery of a first cell size;
a plurality of batteries of sizes different than said first cell size insertable into said insert device, wherein said plurality of batteries power said application.

2. The battery interchangeability system of claim 1 wherein said insert device is side-loaded.

3. The battery interchangeability system of claim 1 wherein said first cell size is chosen from the group consisting of D, C and AA.

4. The battery interchangeability system of claim 1 wherein said plurality of batteries is chosen from the group consisting of C, AA and AAA.

5. The battery interchangeability system of claim 1 further comprising a second insert device insertable into said first insert device, at least one of said plurality of batteries insertable into said second insert device.

6. The battery interchangeability system of claim 1 wherein said plurality of batteries are held in said insert device in a turret arrangement.

7. The battery interchangeability system of claim 6 wherein said turret holds three AA cells.

8. The battery interchangeability system of claim 6 wherein said turret holds four AAA cells.

9. The battery interchangeability system of claim 1 wherein said insert device is made primarily from a polymer material.

10-14. (canceled)

15. A method of using a plurality of smaller battery cells to power an application requiring a larger battery cell comprising:
placing an insert having an outer diameter approximately equal to said larger battery size into said application in place of said larger battery;
placing a plurality of batteries of said smaller battery size into said insert, said insert adapted to receive said smaller batteries;
providing electrical conductivity from battery electrodes in said application to said smaller batteries so that said smaller batteries power, or partially power, said application.

16. The method of claim 15 wherein said larger battery size is chosen from the group consisting of D, C and AA.

17. The method of claim 15 wherein said smaller battery size is chosen from the group consisting of C, AA and AAA.

18. The method of claim 15 wherein said insert is made substantially of a polymer material.

19. The method of claim 15 wherein said smaller battery size and said insert have a length approximately equal.

20. A battery replacement insert comprising a cylinder with outer diameter approximately equal to a first standard round battery cell size and inner diameter approximately equal to a second standard round battery cell size, wherein a plurality of batteries of said second cell size can replace a battery of said first cell size by inserting said batteries of said second cell size into said insert and inserting said insert into an application requiring a battery of said first cell size.

21. A universal battery re-sizer comprising:
a first substantially cylindrical battery insert shell with inside diameter approximately equal to a first battery size outer diameter and outside diameter approximately equal to a second battery size outer diameter;
a second substantially cylindrical battery insert shell with inside diameter approximately, equal to said second battery size outer diameter and outside diameter approximately equal to a third battery size outer diameter;
wherein, alternatively:
a battery of said first size can be inserted into said first insert, and said insert inserted into an application requiring a battery of said second batter size, or
a battery of said second size can be inserted into said second insert, and said second insert can be inserted into an application requiring a battery of said third size, or
a battery of said first size can be inserted into said first insert, said first insert can be inserted into said second insert, and said second insert can be inserted into an application requiring a battery of said third size, and
wherein when said first or second insert containing at least one battery is inserted into an application,
said battery powers said application.

22. The universal battery re-sizer of claim 20 wherein said first battery size is AA.

23. The universal battery re-sizer of claim 20 wherein said second battery size is C.

24. The universal battery re-sizer of claim 20 wherein said third battery size is D.

25. The universal battery re-sizer of claim 20 wherein said first battery size is AAA.
